(19) United States
(12) Patent Application Publication
(10) Pub. No.: US 2010/0234650 A1
(43) Pub. Date: Sep. 16, 2010

(54) Oxygen separation membrane

(75) Inventors: You Cong, Liaoning Province (CN); Weishen Yang, Liaoning Province (CN); Xuefeng Zhu, Liaoning Province (CN)

Correspondence Address: NIXON & VANDERHYE, PC, 901 NORTH GLEBE ROAD, 11TH FLOOR, ARLINGTON, VA, 22203, US

(73) Assignee: BP P.L.C., LONDON (GB)

(21) Appl. No.: 12/308,511

(22) PCT Filed: Jun. 15, 2007
(86) PCT No.: PCT/GB2007/002252

§ 371 Date: Dec. 17, 2008

(30) Foreign Application Priority Data
Jun. 21, 2006 (CN) 200610089352.4
Dec. 18, 2006 (CN) PCTCN2006003438

(51) Int. Cl. C07B 41/00

(52) U.S. Cl. 568/950; 568/959

(57) ABSTRACT

A composition comprising an electron-conducting component and an oxide ion-conducting component, characterised in that the electron-conducting component is also an oxide ion-conductor, the composition being suitable for use in a selective oxygen permeable membrane for separating oxygen from a gaseous mixture comprising oxygen, such as air, the separation optionally being carried out in a reactor comprising a first and second zone, in which an oxygen-containing gas is fed to the first zone, and a reactant fed to the second zone, in which an oxygen consuming reaction occurs in the second zone of the reactor.

This invention relates to the field of separation, more specifically to a composite material that is selectively permeable to oxygen.

Oxygen-permeable membranes may be used to separate oxygen from an oxygen-containing gas, such as air. Typical selective oxygen-permeable membranes comprise a ceramic material that is capable of conducting oxygen ions through the lattice structure at above a certain temperature, and which enables oxygen to permeate through the membrane from one side to the other, from a region of relatively high oxygen partial pressure to a region of relatively low oxygen partial pressure. Examples of ceramic materials suitable for oxygen separation include compounds of formula Srₐ(Fe₁₋ₓCOₓ)_{a+b}O_{d}, as described in U.S. Pat. No. 5,639,437, and substituted analogues, such as Ba_{0.5}Sr_{0.5}CO_{0.8}Fe_{0.2}O_{3-δ} and SrCo_{0.8}Fe_{0.2}O_{3-δ} as described by Shao et al in Journal of Membrane Science, 2000, vol 172, pp 177-188.

A problem with such membrane materials is that they can exhibit poor long term stability, particularly under reducing environments and high pressure gradients, which can limit their applicability.

Composite membranes are known, comprising two or more materials, one of which is capable of conducting oxygen ions, the other of which is an electronic conductor, examples being La_{0.7}Sr_{0.3}MnO_{3-δ} a mixed with Ce_{0.8}Gd_{0.2}O_{2-δ} as reported by Kharton et al in J. Electrochem. Soc., 147, pp 2814-21 (2000). However, a problem with composite membranes is that particles of the different materials must form a continuous network of electronic and oxygen conducting pathways, often requiring a high content of the electron conducting material, which limits oxygen flux (the rate of transport of oxygen through the membrane). Additionally, as oxygen permeability typically occurs at high temperature, different thermal expansion coefficients of the different materials can also lead to degradation of the membrane structure.

According to the present invention, there is provided a composition for a selective oxygen-permeable membrane comprising an electron-conducting component and an oxide ion-conducting component, characterised in that the electron-conducting component is also an oxide ion-conductor.

Oxygen separation membranes typically operate by converting oxygen atoms or molecules at one membrane surface into oxide (O²⁻) ions, and releasing oxygen atoms or molecules at the other surface. In order to achieve this, the membrane needs not only to conduct oxide ions, but also needs to conduct electrons in order to correct any charge imbalance caused by the redox reactions on the respective sides of the membrane.

In composite membranes known in the prior art, for example membranes comprising Ce_{0.8}Gd_{0.2}O_{2-δ} and La_{0.7}Sr_{0.3}MnO_{3-δ} as described by Kharton et al in J. Electrochem. Soc., 147, pp 2814-21 (2000), the separate uncombined materials each have very low oxygen fluxes. For example, at 950° C., La_{0.7}Sr_{0.3}MnO_{3-δ} has an oxygen flux of 6.7×10⁻⁵ ml cm⁻² min⁻¹ or less, while Ce_{0.8}Gd_{0.2}O_{2-δ} has an oxygen flux of below 1×10⁻³ at 940° C. However, when the two materials are combined, high oxygen fluxes can be achieved.

In the present invention, improved oxygen flux through the membrane is achieved by using a composite material having oxide ion-conducting and electron-conducting components, in which the electron conducting component is also an oxide ion conductor. Preferably, the electron conducting component, which is also capable of conducting oxide ions, is capable of achieving an oxygen flux of greater than 1×10⁻³ ml cm⁻² min⁻¹, and most preferably greater than 0.01 ml cm⁻² min⁻¹ at 950° C.

By ensuring the electron conducting component is also an oxide ion-conductor, oxygen flux through the membrane is improved, while maintaining the necessary electronic conductivity to allow charge stabilisation on both sides of the membrane.

Preferably, the material of the oxide ion-conducting component is an oxide of the fluorite structure, which is based on the structure of CaF₂, and is adopted by substances such as CeO₂ and ZrO₂. The structure comprises a face centred cubic arrangement of cations, with the anions occupying the tetrahedral interstices, and have a general formula of MX₂, in which M is the cation and X is the anion. In the case of CeO₂, for example, other rare-earth elements (R) can be substituted to form compounds of general formula Ce₁₋ₓRₓO_{2-(x/2)}. The value of x is typically in the range of from 0.05 to 0.25.

Preferably, the oxide ion-conducting component comprises cerium. More preferably, the oxide ion-conducting component comprises cerium in combination with a second lanthanide element, which is preferably a lanthanide element in common with a lanthanide element in the electron-conducting component of the composition. The second lanthanide is preferably selected from one or more of neodymium (Nd), samarium (Sm) and gadolinium (Gd), and is more preferably Sm and/or Gd. In a preferred embodiment, cerium and gadolinium are present, preferably with a Ce:Gd molar ratio in the range of from 2:1 to 20:1, more preferably in the range of from 2:1 to 10:1, and yet more preferably in the range of from 3:1 to 5:1. Most preferably, the ratio is about 4:1, as found for example in the material Ce_{0.8}Gd_{0.2}O_{1.9}.

The electron-conducting component is also an oxide ion conductor, and is preferably an oxide having a perovskite structure. Perovskite materials have a general formula of ABO_{3-δ}, wherein A and B represent different lattice sites within the perovskite structure occupied by different elements, wherein elements occupying site A are typically larger than those occupying site B. The value of “δ” in relation to the value “3−δ” for the oxygen stoichiometry is dependent on the charges of the various cations within the perovskite structure, the value being that required to make the structure neutral overall. Thus, in a material of formula ABO_{3-δ}, if the A and B cations each have a charge of +3, then δ will equal zero. However, if the A cation has a +2 charge and the B cation has a +3 charge, then δ is equal to 0.5.

In a preferred embodiment of the invention, the electron-conducting component is an oxide comprising a lanthanide, an alkaline earth and a first row transition metal. Preferably, the lanthanide used is the same as a lanthanide element used in the oxide ion-conducting component, being preferably selected from Nd, Sm and Gd, more preferably Sm and/or Gd, and is most preferably Gd. The alkaline earth is preferably strontium (Sr).

The first row transition metal is preferably iron. In a further embodiment of the invention, the electron-conducting component comprises Gd, Sr and Fe, in which the Gd:Sr mole ratio is typically in the range of from 1:2 to 1:8, preferably from 1:3 to 1:5, and more preferably about 1:4. The Gd:Fe mole ratio is typically in the range of from 1:1 to 1:10, preferably in the range of from 1:3 to 1:7, and more preferably about 1:5. Most preferably, the electron conducting oxide comprises a Gd:Sr:Fe mole ratio of about 2:8:10, for example in Gd_{0.2}Sr_{0.8}FeO_{3-δ}, where δ represents the correction required to charge balance the formula.

Compositions in which the phases of the two different components are the same are typically avoided, as this can result in mixing of the compositions due to migration of the respective elements of the different components. This can result in reduction and even loss of the oxide ion and/or electronic conducting properties of either or both of the components. Therefore, in a preferred embodiment of the invention, the phases of the two different components are different from each other. More preferably, the phase of the oxide ion-conducting component is perovskite, and that of the electron-conducting component is a fluorite.

Having an electron-conducting component and an oxide ion-conducting component each comprising a common lanthanide is advantageous, as any migration of lanthanide between the two components that does take place will less likely result in the alteration of the crystalline structure of the components, which results in less degradation and improved lifetime of the membrane when used in high temperature applications, such as during use as a selective oxygen-permeable membrane for oxygen separation.

The weight ratio of the electron-conducting component to the oxide ion-conducting component is selected so as to give the optimum oxide ion conductivity, coupled with high oxygen selectivity. Typically the weight ratio of the electron-conducting component to the oxide ion-conducting component is in the range of from 1:4 to 4:1, preferably in the range of from 1:3 to 1:1, and is most preferably about 2:3.

The composition of the present invention may be used to form a selective oxygen-permeable membrane for separating oxygen from a mixture comprising oxygen, for example air.

In one embodiment, the membrane additionally comprises a porous layer of a material that acts to enhance the rate of oxygen exchange at the membrane surface. An example of such a material is an oxide comprising La, Sr and Co with a perovskite structure, preferably La_{0.6}Sr_{0.4}CoO_{3-δ}.

Oxygen separation from air can be achieved by feeding air into a first zone of a separation vessel having two zones, which two zones are separated by the selective oxygen-permeable membrane. Conditions are maintained in each of the two zones of the vessel and at the membrane such that oxygen transfers from the first zone, through the membrane and into the second zone. Permeation through the membrane is dependent, inter alia, on the partial pressure of oxygen on each side of the membrane. Thus, to transfer oxygen from the first zone of the vessel to which the air is fed, there must be a lower partial pressure of oxygen in the second zone on the other side of the membrane. To achieve this, the second zone can be free of oxygen before oxygen permeation takes place, or must have a lower partial pressure of oxygen. As a consequence of permeation, the oxygen levels in the air in the first zone of the separator vessel are depleted.

The membrane, when in use, is maintained under conditions that allow the selective permeation of oxygen. Typically, this necessitates a temperature of in excess of 700° C., preferably 850° C. or more, in order to ensure a sufficient rate of oxygen activation at the surface of the membrane. The temperature of the membrane is also typically maintained below 1400° C., preferably 1100° C. or less, to prevent degradation of the membrane structure, which can negatively impact oxygen flux. The partial pressure of oxygen in the second zone of the permeation vessel (the permeate side of the membrane) is less than the partial pressure in the first zone of the membrane in order to allow a net transfer of oxygen from the first to the second zone.

Use of a selective oxygen permeable membrane to provide purified oxygen is less energy intensive than conventional cryogenic techniques, and thus can be operated more viably on a smaller scale. This allows the possibility of providing small-scale, locally situated oxygen generation units for a process that may require purified oxygen, as opposed to either requiring the import of oxygen that has to be transported from a large-scale remote facility, or necessitating locating the process in the vicinity of such a large scale oxygen production unit.

In a further embodiment of the invention, the selective oxygen-permeable membrane is part of a reactor comprising two zones, which two zones are separated by the membrane. The reactor can be used for performing reactions in oxygen-consuming reactions, including reactions in which a reducing atmosphere is present, for example reactions involving syngas, such as the steam reforming and/or partial oxidation of hydrocarbons to produce one or more oxides of carbon. In this embodiment, one or more reactants are fed to the second zone of the reactor, which may additionally comprise a catalyst. An oxygen-containing gas, such as air, is fed to the first zone of the reactor. In use, oxygen in the first zone of the reactor permeates through the membrane into the second zone of the reactor, in which the reaction takes place.

In a preferred embodiment of the invention, the second zone of the separation vessel is a reaction zone for the production of syngas by steam reforming and/or partial oxidation of a hydrocarbon. In this embodiment, oxygen from air permeates through the membrane from the first zone of the separation vessel and into the second zone for use as a reactant in the partial oxidation and/or steam reaction occurring therein. Such an embodiment is advantageous as oxygen can be distributed throughout the syngas production reaction zone, which can reduce the probability of potentially explosive mixtures with high oxygen concentrations being created in poorly mixed regions of the reaction zone. Additionally, separating air in situ can reduce or even eliminate the need for a dedicated and expensive air separation unit.

Syngas (a mixture of carbon monoxide and hydrogen) is preferably produced from natural gas, which comprises predominantly methane. Reaction temperature is typically similar to or the same as the temperature of the membrane, preferably in the range of from 850 to 1100° C. The total pressure within the reaction zone is typically maintained in the range of from 1 to 200 bara (0.1 to 20 MPa). For oxygen to be able to permeate the membrane into the reaction zone, the oxygen partial pressure in the second zone of the reactor must be less than that in the first zone of the reactor.

Optionally, the reaction zone may also comprise a hydrogen separation membrane, in which the hydrogen produced can be selectively separated from the reaction zone and used, for example, to produce energy.

Compositions in accordance with the present invention can be made by mixing the two separate components in powder form and compressing them together. Typically, the mixed powder is subsequently calcined at high temperature, typically in an oxygen-containing atmosphere at temperatures of up to 1400° C., for example in the range of from 700 to 1400° C.

The separate components may be synthesised by various techniques, for example by high temperature synthesis using mixed oxides of the various constituent elements, or by precipitating an oxide from a solution comprising soluble compounds of the constituent elements. In the latter case, the resulting precipitate, which may be amorphous, is typically calcined at high temperature to form the desired crystalline phase.

The invention will now be illustrated by the following non-limiting example, and with reference to the Figures in which;

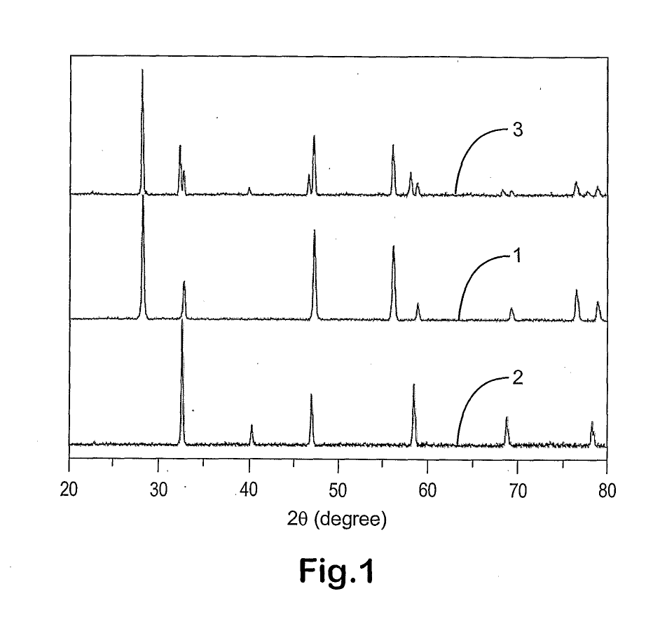

FIG. 1 shows X-ray diffraction (XRD) patterns for a membrane made from a composition according to the present invention, in addition to XRD patterns of the constituent components;

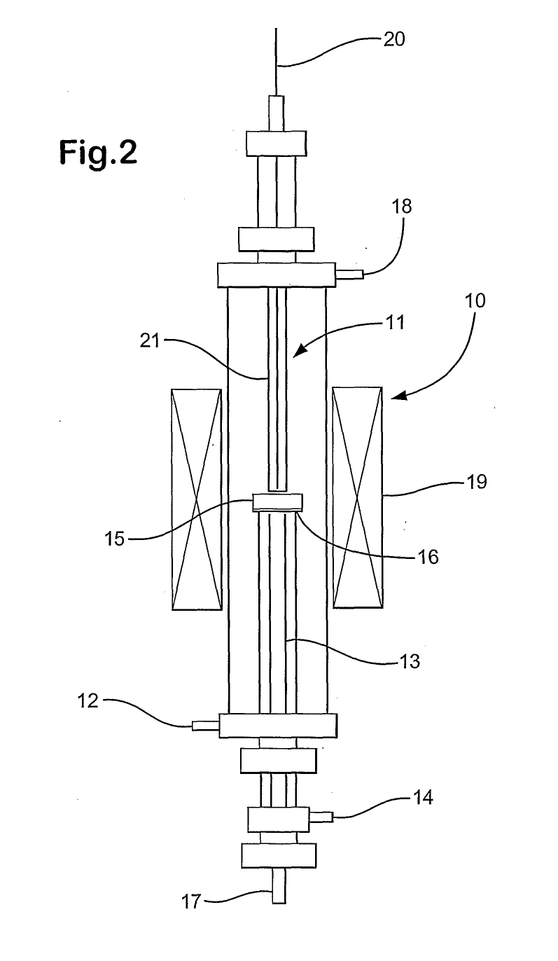

FIG. 2 schematically illustrates the apparatus used for oxygen permeation experiments;

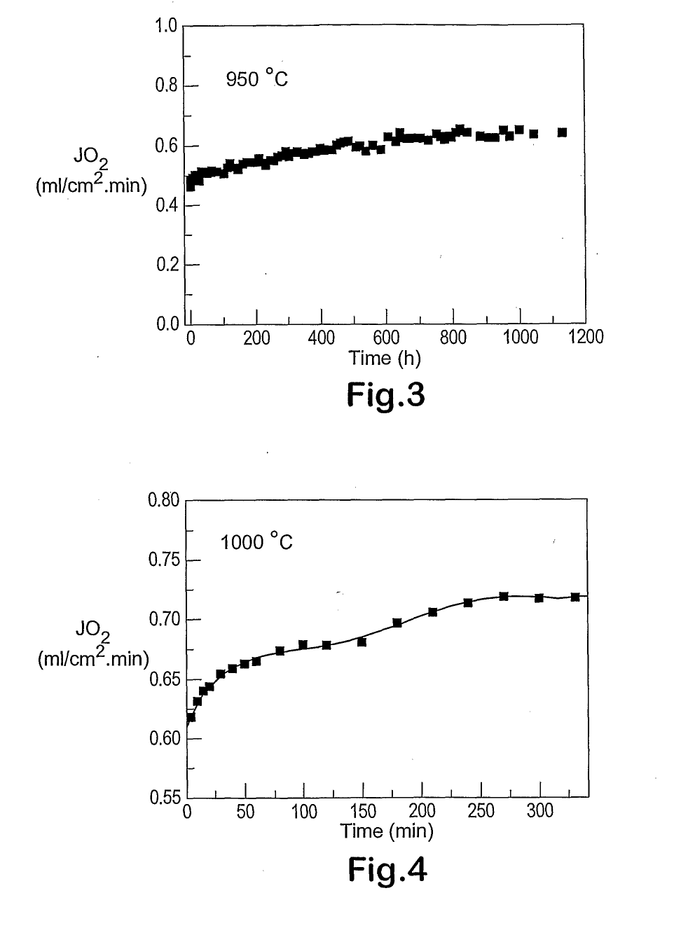

FIG. 3 is a plot of oxygen flux against time at 950° C. for a selective oxygen-permeable membrane made from a composition in accordance with the present invention;

FIG. 4 is a plot of oxygen flux against time, at 1000° C. for a selective oxygen-permeable membrane made from a composition in accordance with the present invention;

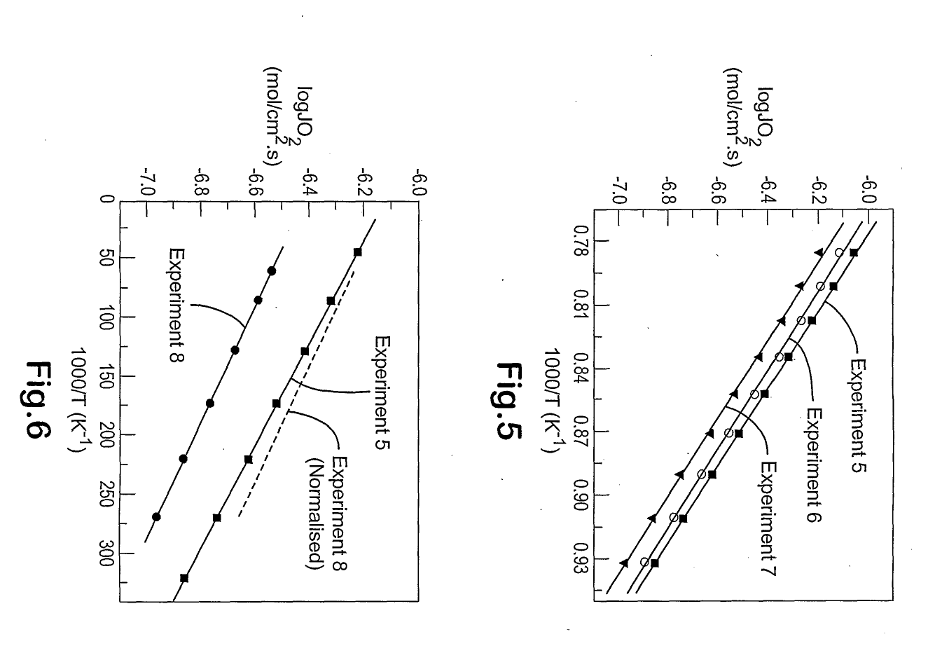

FIG. 5 is a plot of oxygen flux against the reciprocal of temperature at different oxygen partial pressure differentials for a Membrane made from a composition in accordance with the present invention;

FIG. 6 is a plot of oxygen flux against the reciprocal of temperature for different thicknesses of a membrane made from a composition in accordance with the present invention;

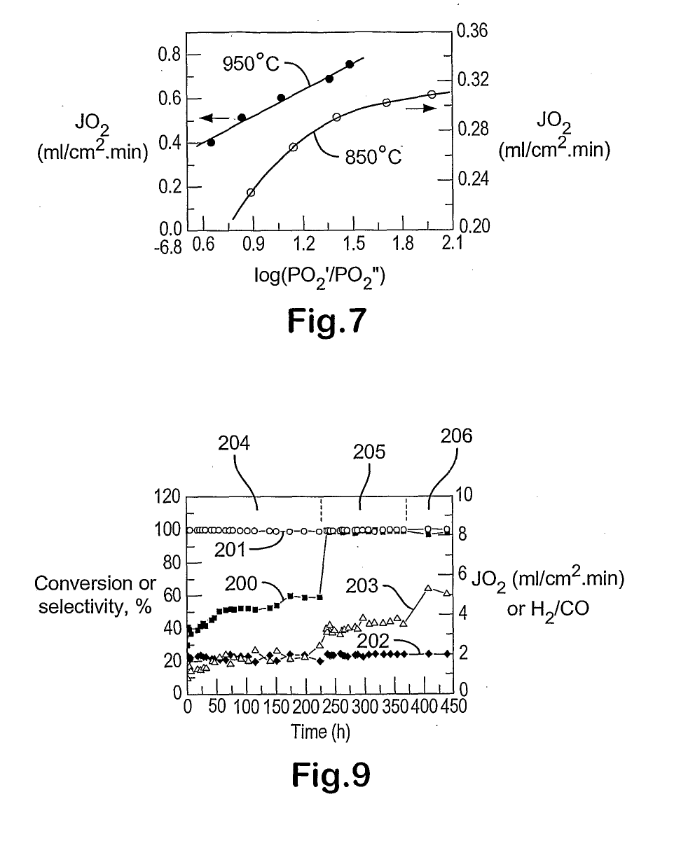

FIG. 7 is a plot of oxygen flux against the log of the partial pressure differential across a membrane made from a composition in accordance with the present invention;

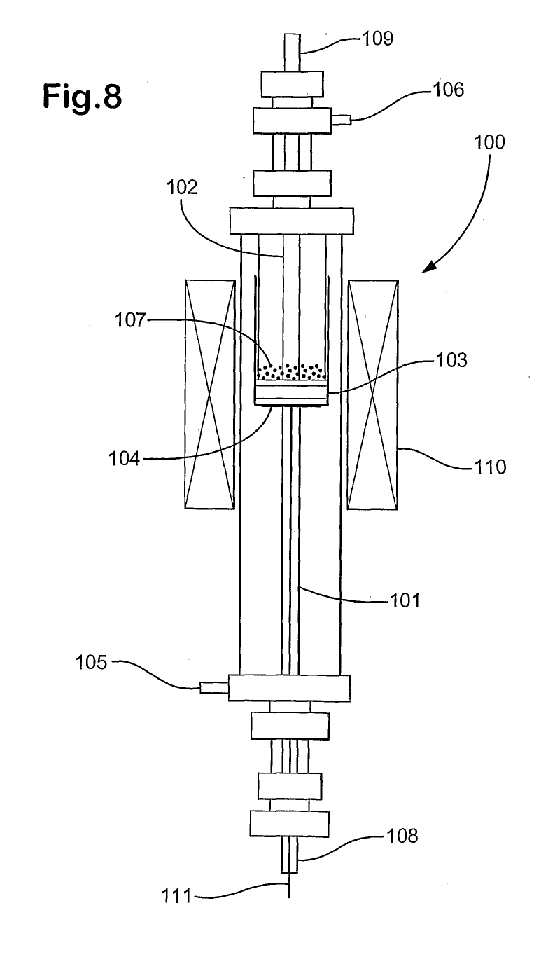

FIG. 8 schematically illustrates a process using a reactor with a selective oxygen-permeable membrane, in which oxygen is separated from air in one zone of the reactor and fed into a second zone of the reactor for use as a reactant in the catalytic partial oxidation of methane; and

FIG. 9 is a plot of catalytic performance and oxygen permeation performance in the partial oxidation of methane using a reactor with a selective oxygen-permeable membrane made from a composition in accordance with the present invention;

A composition in accordance with the present invention was prepared by separately synthesising Gd_{0.2}Ce_{0.8}O_{1.9} (GDC) and Gd_{0.2}Sr_{0.8}FeO_{3-δ} (GSF). Nitrate salts of the metals in respective stoichiometric quantities were dissolved in water. A quantity of EDTA and citric acid were each added so that the molar ratio of each of the EDTA and citric acid to the total quantity of metal ions was 1. The pH of the solution was then adjusted to a value of between 6 and 8 by addition of ammonium hydroxide solution. Water was removed by evaporation at about 80° C. using a hot-plate. A gel formed, which was then ignited with a flame in order to combust residual organic material. The resulting powder was subsequently calcined under air for 5 hours at 900° C. to yield the respective oxide product.

Membranes were prepared using the following procedures.

### EXAMPLE 1

Powders of each of the GDC and GSF compounds were mixed together in a ratio of 60 wt % GDC to 40 wt % GSF. They were then compressed into a disc at a pressure of 200 MPa, and heated at 1400° C. for a period between 3 and 5 hours to form the final composition (GDC60/GSF40), which could also be used as a selective oxygen-permeable membrane in subsequent experiments. The disc of GDC60/GSF40 was polished to a thickness of 0.5 mm, and a coating of a porous La_{0.6}Sr_{0.4}CoO_{3-δ} (LSC) was applied in order to improve oxygen exchange at the membrane surface. This was achieved by preparing a paste of 40 wt % LSC in 60 wt % terpineol-saturated methyl cellulose, applying a coating of the paste to the membrane, and calcining the coated membrane at 900° C. in air for one hour.

### COMPARATIVE EXAMPLE 2

GSF-only and GDC-only membranes were formed by compressing a disc of GSF or GDC at 200 MPa, and heating it to a temperature of 1250° C. for 3 hours. The disc was then polished and coated with LSC in an identical way to the membrane of example 1.

### Experiment 1

X-ray diffraction (XRD) patterns, as shown in FIG. 1, were measured for the pure GDC 1 and GSF 2 compounds, and also for the GDC60/GSF40 membrane 3. XRD patterns were collected before any LSC coating was applied. A Rigaku D/Max-RB diffractometer was used, employing Cu Kα radiation. Data were collected over a 2θ range of 20-80° in steps of 0.02°.

The data show that the membrane composition, after mixing and treatment at 1400° C., comprises a mixture of the two constituent phases; no new phase is apparent. The data also show that GSF adopts a perovskite structure, and GDC adopts a fluorite structure.

### Experiment 2

An LSC-coated disc of GDC or GSF was loaded into a vertical high-temperature gas permeation cell. On one side of the membrane (corresponding to the first zone of the vessel), a flow of a dry mixture of 80% nitrogen and 20% oxygen by volume was introduced at a rate of 100 mL/min (adjusted to standard temperature and pressure (STP), i.e. 0° C. and 1 atm pressure). A helium (or methane) sweep gas was fed to the other side of the membrane (corresponding to the second zone of the vessel) to assist removal of permeated oxygen. A schematic overview of the oxygen separation process is illustrated in FIG. 2. The separation vessel 10 comprises two zones, a first zone 11 to which air is fed through inlet 12, and a second zone 13 to which a helium sweep gas is fed through inlet 14. The membrane 15, sealed by a silver ring 16, separates the first 11 and second 13 zones. Oxygen permeating through the membrane from the first to the second zone is swept out of the separation vessel by the helium sweep gas through outlet 17. Oxygen-deficient air that does not permeate the membrane is removed from the first zone through outlet 18.

In oxygen permeation experiments, the membrane was maintained at a temperature of 940° C. using heater 19. Temperature at the membrane was measured using a thermocouple 20 located within a thermowell 21 which extended to a point just above the membrane 15. An oxygen partial pressure of 21 kPa was maintained in the first zone.

For the GDC membrane, the initial oxygen flux was below detectable limits, i.e. less than 0.001 mL cm⁻² min⁻¹.

For the GSF membrane, the helium flow on the permeate side of the membrane was adjusted to give an oxygen partial pressure of 5 kPa. The initial oxygen flux across the membrane was 0.26 mL cm⁻² min⁻¹.

These experiments show that GDC, in the absence of electronic conductivity, does not function effectively as a selective oxygen-permeable membrane. GSF, however, having both electronic and oxide conductivity, can allow the selective permeation of oxygen.

### Experiment 3

An LSC-coated disc of GDC60/GSF40 was subjected to the same procedure as described in experiment 2, with the exception that the temperature of the membrane (gases) was 950° C., and the experiment was continued for a period of 1100 hours. A plot of oxygen flux (JO₂) in units of ml cm⁻² min⁻¹ against time is shown in FIG. 3.

The results show that oxygen flux increased steadily over the first 600 hours on stream, the initial flux of 0.46 mL cm⁻² min⁻¹ increasing to 0.63 mL cm⁻² min⁻¹.

### Experiment 4

The same procedure as described in Experiment 3 was used for a GDC60/GSF40 membrane, with the exception that the temperature of the membrane (gases) was 1000° C. and the period of time on stream was 350 hours. A plot of oxygen flux against time is shown in FIG. 4.

The results show that oxygen flux was higher than at 950° C., which flux also increased with time on stream. The membrane exhibited an initial flux of 0.61 mL cm⁻² min⁻¹, which increased to 0.71 mL cm⁻² min⁻¹ within the first 300 hours on stream.

### Experiment 5

Oxygen flux through a GDC60/GSF40 membrane at temperatures of between 800° C. and 1010° C. was studied. A flow of 100 mL/min (STP) of the oxygen-nitrogen mixture at an oxygen partial pressure of 21 kPa on one side of the membrane was used, and the helium gas flow on the other (permeate) side of the membrane was adjusted to give an oxygen partial pressure of 0.5 kPa.

### Experiment 6

The procedure was the same as Experiment 5, except that the helium gas flow on the other (permeate) side of the membrane was adjusted to give an oxygen partial pressure of 1.0 kPa.

### Experiment 7

The procedure was the same as Experiment 5 and 6, except that the helium gas flow on the other (permeate) side of the membrane was adjusted to give an oxygen partial pressure of 2.0 kPa.

Results of oxygen flux versus the reciprocal of temperature at different oxygen partial pressure differentials for Experiments 5 to 7 are shown in FIG. 5. The results show that oxygen flux increases with temperature, and with an increase in the oxygen partial pressure differential.

### Experiment 8

The same procedure as Example 6 was followed, except that a 1.0 mm GDC60/GSF40 membrane was used, at temperatures of between 825° C. and 940° C. An oxygen partial pressure on the permeate side of the membrane was maintained at a value of 1.0 kPa.

Results of oxygen flux against the reciprocal of temperature for membranes of different thickness for Experiments 5 and 8 are shown in FIG. 6. The results show that oxygen flux is higher for the thinner membrane.

Table 1 shows the calculated oxygen permeation activation energies for Experiments 5 through to 8.

TABLE 1
Oxygen Permeation Activation Energies

| | Membrane | | Activation |
|---|---|---|---|
| | Thickness | | Energy |
| Experiment | (mm) | J O₂ (kPa)¹ | (kJ/mol) |
| 5 | 0.5 | 0.5 | 105.3 |
| 6 | 0.5 | 1.0 | 103.4 |
| 7 | 0.5 | 1.5 | 104.6 |
| 8 | 1.0 | 1.0 | 94.5 |

¹oxygen partial pressure on the permeate side of the membrane.

The higher activation energies calculated for the 0.5 mm membrane indicate that oxygen exchange at the membrane surface is more important on the oxygen flux than in the 1.0 mm membrane, in which the bulk of the membrane has greater influence on oxygen flux. This is also demonstrated by the dashed line on the plot of FIG. 6, which represents the predicted oxygen flux of the 1.0 mm membrane of Experiment 8 corrected or normalised to 0.5 mm. The flux is predicted to be higher than is actually observed (c.f. results of Experiment 5), and the difference increases at lower temperatures, showing the increased importance of surface exchange over bulk diffusion for the thinner membrane.

FIG. 7 shows the results of oxygen flux versus the log of the partial pressure differential for the 0.5 mm membrane at two different temperatures, 850 and 950° C. In this case, the partial pressure differential is expressed as the ratio between the oxygen partial pressure in the oxygen/nitrogen mixture (PO₂′) and the oxygen partial pressure in the oxygen/helium mixture on the permeate side of the membrane (PO₂″).

The results show that at 950° C. the gradient is constant, indicating bulk diffusion is the main factor limiting oxygen flux. Conversely, at 850° C., the gradient is non-linear, being larger at lower oxygen partial pressure differentials, indicating that surface exchange becomes important at this lower temperature.

### Experiment 9

The use of a 0.5 mm GDC60/GSF40 membrane to directly separate pure oxygen from air, for feeding to a reaction for the partial oxidation of methane to carbon monoxide and hydrogen was studied. The membrane was loaded into a membrane reactor, the membrane separating the reactor into two zones. Into one of the zones (the second zone) was introduced a LiLaNiO/γ-alumina partial oxidation catalyst, which had been prepared by an impregnation method in which gamma-alumina was immersed for 24 hours in a solution comprising lithium nitrate, nickel(II) nitrate and lanthanum(III) nitrate in a 1:1.6:2.6 Ni:Li:La mole ratio. The resulting catalyst had a nickel loading of between 5 and 10% by weight. The catalyst was not pre-reduced before being loaded into the reactor. A schematic overview of the process is illustrated in FIG. 8, which shows a reactor 100 with a first zone 101 and a second zone 102 separated by a selective oxygen-permeable membrane 103, sealed using gold rings 104. Air is fed to the first zone 101 through inlet 105. Oxygen permeating the membrane 103 enters the second zone 102 of the reactor. To the second zone of the reactor is fed a hydrocarbon, for example methane 106. The second zone also contains a partial oxidation catalyst 107. The methane combines with the permeated oxygen in the presence of the catalyst 107, and reaction occurs. An oxygen/nitrogen mixture with reduced oxygen concentration is removed from the first zone 101 of the reactor through outlet 108, while a stream comprising unreacted methane and oxygen, together with reaction products and by-products is removed from the second zone of the reactor through outlet 109.

Initially, a flow of 5 mL/min pure methane (STP) diluted with a flow of 20 mL/min helium (STP) was introduced into the second zone of the reactor (the catalyst-containing zone). Air was introduced into the first reactor zone at a flow of 150 mL/min (STP). The membrane was held at a temperature of 950° C. using heater 110, as measured using thermocouple 111, and total pressures of 1 atm on both sides of the membrane were maintained.

Results are reproduced graphically in FIG. 9, which displays methane conversion, 200 (▪), CO selectivity 201 (∘), H₂:CO molar ratio, 202 (♦), and oxygen flux, 203 (Δ). After 30 minutes on stream, methane conversions of 30% were observed, with a selectivity to CO of 100% and an oxygen permeation flux of 0.85 mL cm⁻² min⁻¹. After about 230 hours on stream, the conversion had increased to 60%, with an oxygen flux of 2.4 mL cm⁻¹ min⁻¹. These results correspond to region 204 of the graph in FIG. 9. The helium flow to the second (catalyst-containing) reactor zone was then switched off, which resulted in an increase in methane conversions to 99%, and an increase in oxygen flux to 3.3 mL cm⁻² min⁻¹. These results correspond to region 205 of the graph FIG. 9. After 380 hours on stream, the CH₄ flow rate was increased to 10 mL/min (STP). This resulted in an increased oxygen flux of 5.2 mL cm⁻² min⁻¹, while conversion remained at 99%. These results correspond to region 206 of the graph in FIG. 9. Selectivity to CO throughout the experiment was 100%, and the H₂:CO mole ratio was consistently 2:1, with only minor variations being experienced.

The results show that partial oxidation using an oxygen-membrane reactor with a membrane made of a composition in accordance with the present invention can produce high methane conversions with high carbon monoxide selectivity over several hours on-stream, even when one side of the membrane is in contact with a hydrogen-containing reducing atmosphere at high temperatures and pressures.

1.-29. (canceled)

30. A composition for a selective oxygen-permeable membrane comprising an electron-conducting component and an oxide ion-conducting component, which electron-conducting component is also an oxide ion-conductor, characterised in that the oxide-ion conducting component and the electron-conducting component comprise a common lanthanide element.

31. A composition as claimed in claim 30, in which the oxygen flux through the electron-conducting component is greater than 1×10⁻³ ml cm⁻² min⁻¹ at 950° C.

32. A composition as claimed in claim 30, in which the oxide ion-conducting component is an oxide with the fluorite structure.

33. A composition as claimed in claim 30, in which the electron-conducting component is an oxide with a perovskite structure.

34. A composition as claimed in claim 30, in which the oxide-conducting component comprises cerium and a second lanthanide element.

35. A composition as claimed in claim 30, in which the electron-conducting component comprises a lanthanide element, an alkaline earth element and a first row transition element.

36. A composition as claimed in claim 34, in which the oxide ion-conducting component comprises cerium and gadolinium.

37. A composition as claimed in claim 36, in which the molar ratio of Ce:Gd is the range of from 2:1 to 8:1.

38. A composition as claimed in claim 37, in which the molar ratio of Ce:Gd is in the range 1:3 to 1:5.

39. A composition as claimed in claim 30, in which the electron-conducting component comprises gadolinium, strontium, and iron.

40. A composition as claimed in claim 39, in which the Gd:Sr mole ratio is in the range of from 1:2 to 1:8, and the Gd:Fe mole ratio is in the range of from 1:1 to 1:10.

41. A composition as claimed in claim 40, in which the Gd:Sr mole ratio is in the range of from 1:3 to 1:5.

42. A composition as claimed in claim 39, in which the Gd:Fe mole ratio is in the range of from 1:3 to 1:7.

43. A selective oxygen-permeable membrane comprising a composition according to claim 30.

44. A selective oxygen-permeable membrane as claimed in claim 43, in which there is a coating layer of a material for enhancing oxygen exchange at the membrane surface.

45. A selective oxygen-permeable membrane as claimed in claim 44, in which the coating layer is an oxide with a perovskite structure comprising the elements La, Sr and Co.

46. Use of a selective oxygen permeable membrane according to claim 43 for the separation of oxygen from a gaseous mixture comprising oxygen.

47. Use of a selective oxygen permeable membrane as claimed in claim 46, in which the gaseous mixture comprising oxygen additionally comprises nitrogen.

48. Use of a selective oxygen permeable membrane as claimed in claim 47, in which the gaseous mixture is air.

49. Use of a selective oxygen permeable membrane according to claim 43, in which the separation is carried out at a temperature of above 700° C. and below 1400° C.

50. Use of a selective oxygen permeable membrane according claim 49, in which the separation is carried out at a temperature in the range of from 850 to 1100° C.

51. A process for performing an oxygen-consuming reaction comprising feeding a reactant to the second zone of a reactor having a first and a second zone separated by a selective oxygen-permeable membrane, and feeding an oxygen-containing gas to the first zone of the reactor, such that the conditions in the first and second zones of the reactor and the membrane are maintained such that oxygen selectively permeates from the first to the second zone, at least a portion of which is consumed in the oxygen-consuming reaction, characterised in that the selective oxygen permeable membrane is a membrane according to claim 43.

52. A process as claimed in claim 51, in which the reactant is a hydrocarbon, and the oxygen-consuming reaction is the steam reforming and/or the partial oxidation of the hydrocarbon.

53. A process as claimed in claim 52, in which the process is partial oxidation of the hydrocarbon.

54. A process as claimed in claim 52, in which the hydrocarbon is methane.

55. A process as claimed in claim 51, in which the oxygen-containing gas is air.

56. A process as claimed in claim 51, in which the second reactor zone comprises a catalyst active for the oxygen-consuming reaction.

57. A process as claimed in claim 51, in which the membrane is maintained at a temperature of above 700° C. and below 1400° C.

58. A process as claimed in claim 57, in which the membrane is maintained at a temperature in the range of from 850 to 1100° C.
